(19) United States
(12) Patent Application Publication
(10) Pub. No.: US 2009/0328188 A1
(43) Pub. Date: Dec. 31, 2009

(54) CONTEXT-BASED SEMANTIC FIREWALL FOR THE PROTECTION OF INFORMATION

(75) Inventors: David L. RAYMER, Watauga, TX (US); Barry MENICH, South Barrington, IL (US); John C. STRASSNER, North Barrington, IL (US)

Correspondence Address: FLEIT, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 12/113,669

(22) Filed: May 1, 2008

(51) Int. Cl. G06F 21/20; G06F 15/16

(52) U.S. Cl. 726/14; 726/3; 726/11

(57) ABSTRACT

A method, information processing system, and network limit access to an electronically available information asset. A request (304) from a source (204) to exchange an electronically available information asset with at least one destination (206) is received. An identity (306) associated with the source (204) and the destination (206) is established. A semantically augmented context (226) is generated. The semantically augmented context is information used to identify a meaning and a behavior of the context (226). The request is analyzed relative to the semantically augmented context (226) for determining whether the request is to be one of allowed and denied. The source (204) is allowed to exchange the electronically available information asset with the destination (206) when the request is determined to be allowed. The source (204) is prevented from exchanging the electronically available information asset with the destination (206) when the request is determined to be denied.

### FIELD OF THE INVENTION

The present invention generally relates to the field of network traffic monitoring and management, and more particularly relates to preventing unauthorized access to electronically available information assets.

### BACKGROUND OF THE INVENTION

In the highly competitive world of today, information is arguably one of the most valuable assets within a corporation. The protection of information is paramount and begins with ensuring that only those individuals or groups that need to have access to information actually do have access to the information. Ideally, the inappropriate sharing of information only occurs accidentally; however, reality indicates that the most common source of corporate espionage are the employees of the corporation itself.

Current solutions such as traditional firewalls do not provide an efficient or flexible method for protecting information. For example, traditional firewalls make their decisions based on a set of pre-defined rules that look at common properties associated with ingress and egress traffic that passes through them. This is done to protect a set of resources from the rest of the network. In particular, traditional firewalls have little if any knowledge of the information that is to be protected in these resources; rather, they examine the protocols that carry these data and look for anomalies in the operation of the protocol and/or routing to disallowed source and/or destination addresses.

Recently, applications have been built to extend the above concept of protection, or “firewalling”, can dynamically adapt to incoming requests, such as those made from Grid applications (which appear like DoS attacks). One example of this is the Semantic Firewall project, which deals with the enforcement of network security policies between different trust domains in the presence of dynamically changing and unpredictable Grid communication needs. This project uses semantic reasoning methods to provide dynamic, adaptive network security through adapting the firewall rules.

In contrast, the various embodiments of the present invention focus on the improper exchange of information. This is very different than making the firewall itself adapt to changing legitimate requests. The semantic firewall of the various embodiments of the present invention is not a firewall in the classic sense of the term, but rather an application that annotates data in a manner that can be used by a filtering application at a later stage in the processing of the information.

Therefore a need exists to overcome the problems with the prior art as discussed above.

### SUMMARY OF THE INVENTION

In one embodiment, a method for limiting access to an electronically available information asset is disclosed. The method includes receiving a request from a source to exchange an electronically available information asset with at least one destination. An identity associated with the source and the destination is established in response to the receiving. A semantically augmented context is generated. The semantically augmented context is information used to identify a meaning and a behavior of the context. The request is analyzed relative to the semantically augmented context for determining whether the request is to be one of allowed and denied. The source is allowed to exchange the electronically available information asset with the destination in response to determining that the request is to be allowed. The source is prevented from exchanging the electronically available information asset with the destination in response to determining that the request is to be denied.

In another embodiment, an information processing system for limiting access to an electronically available information asset is disclosed. The information processing system includes a memory and a processor that is communicatively coupled to the memory. The information processing system also includes a semantic firewall module that is communicatively coupled to the memory and the firewall. The semantic firewall is adapted to receive a request from a source to exchange an electronically available information asset with at least one destination. An identity associated with the source and the destination is established in response to the receiving. A semantically augmented context is generated. The semantically augmented context is information used to identify a meaning and a behavior of the context. The request is analyzed relative to the semantically augmented context for determining whether the request is to be one of allowed and denied. The source is allowed to exchange the electronically available information asset with the destination in response to determining that the request is to be allowed. The source is prevented from exchanging the electronically available information asset with the destination in response to determining that the request is to be denied.

In yet another embodiment, a network for limiting access to an electronically available information asset is disclosed. The network includes at least one source node and at least one destination node. The network also includes an information processing system that is communicatively coupled to the source node and the destination node. The information includes a semantic firewall module that is communicatively coupled to the memory and the firewall. The semantic firewall is adapted to receive a request from a source to exchange an electronically available information asset with at least one destination. An identity associated with the source and the destination is established in response to the receiving. A semantically augmented context is generated. The semantically augmented context is information used to identify a meaning and a behavior of the context. The request is analyzed relative to the semantically augmented context for determining whether the request is to be one of allowed and denied. The source is allowed to exchange the electronically available information asset with the destination in response to determining that the request is to be allowed. The source is prevented from exchanging the electronically available information asset with the destination in response to determining that the request is to be denied.

An advantage of the foregoing embodiments of the present invention is that a semantic firewall compares the semantics of the information sent to the semantic firewall with the semantics of the access rules that are used by the semantic firewall using semantic equivalency testing. This semantic firewall, based on this analysis, then applies policies and role-based access control mechanisms (such as role-based rules) to determine if the information exchange is to be allowed to other destinations, both within a network implementing the semantic firewall and in external computer networks. Another advantage is that the semantic firewall can automatically expand the distribution of the information to required parties, additional sites, and other recipients, based on the application of policy and role-based access control mechanisms after the completion of associated semantic analysis. Yet another advantage is that the semantic firewall of the various embodiments of the present invention can annotate data/content in a manner that can be used by a filtering application at a later stage in the processing of the information pipeline.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general overview of an operating environment according to one embodiment of the present invention;

FIG. 2 illustrates a more detailed view of a the operating environment of FIG. 1 implementing a semantic firewall according to one embodiment of the present invention;

FIG. 3 is an operational flow diagram illustrating a process of protecting electronically available information assets according to one embodiment of the present invention; and

FIG. 4 is a block diagram illustrating a detailed view of an information processing system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

General Operating Environment

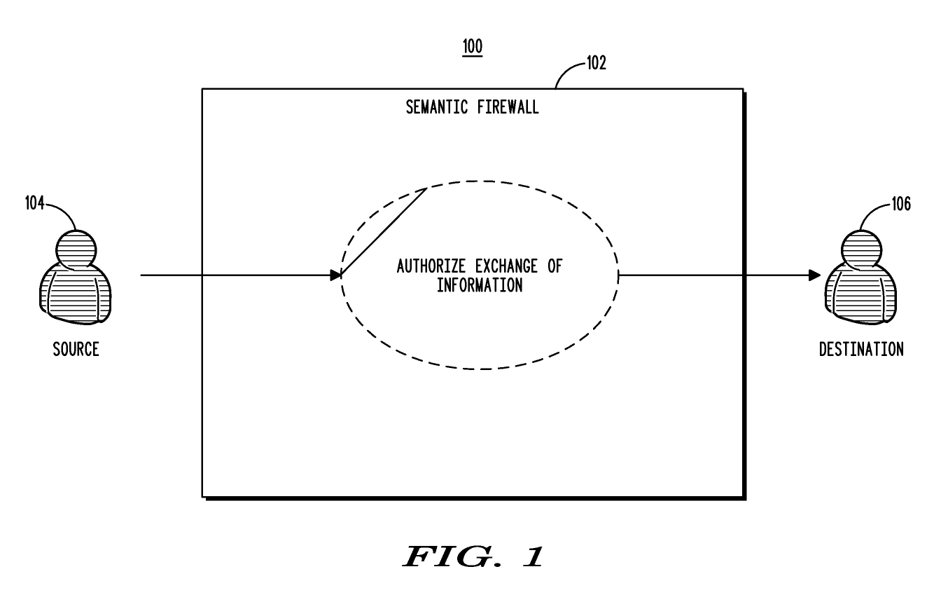

According to one embodiment of the present invention as shown in FIG. 1, a general overview of an operating environment 100 implementing an application gateway component 102 is shown. The application gateway component 102, in one embodiment, is a semantic firewall or comprises a semantic firewall and hereon is referred to as the “semantic firewall 102”. The semantic firewall 102 embodies capabilities of existing internet access proxy applications and traditional IP firewalls, extended to integrate semantic contextual analysis of exchanges to further prevent the undesired or unauthorized dissemination of electronically available information assets. Electronically available information assets can include (but are not limited to) email, email server lists, email address, instant messages, test messages, multimedia messages, HTML documents, XML documents, information comprising RDF and/or OWL, electronic word processor documents, electronic spreadsheet documents, electronic databases, ontologies, and information and data models. Various use cases can be considered in terms of the contextual aspect of the problem. For example, one case is where a context is created, examined, and then discarded and another case is the situation where a context is created and then repeatedly examined, modified, and re-examined before being discarded.

FIG. 1 shows a general implementation of the semantic firewall 102 according to one embodiment of the present invention. For example, FIG. 1 shows the semantic firewall 102 operating in a supervisory mode, juxtaposed between a desired source 104 and a destination 106. The source is trying to send information, which can be referred to as content, to the destination 106. In one embodiment of FIG. 1, the semantic firewall 102 is implemented as a proxy to overcome the addition of new protocols within the system utilizing the semantic firewall 102. The proxy mediates requests between two different protocols to avoid retooling each protocol.

In this embodiment, information exchange requests are sent to an entity that implements the semantic firewall functionality, and if the exchange is allowed, forwarded to an application component that implements the exchange protocol requested. For example, rather than integrate the semantic firewall property into every implementation of every information exchange protocol (e.g., transmission protocol), a proxy application that appears to implement the protocol is created. This proxy application implements the protocol only so far as to mediate requests to exchange information. Stated differently, this proxy application implements the interface defined by the exchange protocol expected by the client, performs the contextual based semantic firewall behavior, and then forwards the request on to a preconfigured application instance that implements the actual information exchange protocol. In other embodiments, the semantic firewall functionality is implemented directly into the application component that implements the desired information exchange protocol, e.g., a POP3 (Post Office Protocol version 3) server that provides SMTP (Simple Mail Transport Protocol) electronic mail service.

It should be noted that the semantic firewall 102 can reside on a wireless device such as (but not limited to) a two-way radio, a cellular telephone, a mobile phone, a smartphone, a two-way pager, a wireless messaging device, and a residential gateway. The semantic firewall 102, can also reside on an information processing system such as (but not limited to) a workstation, server, laptop, and a desktop. Network components such as (but not limited to) routers, switches, hubs, and gateways can also include the semantic firewall 102. As can be seen, the semantic firewall 102 can be situated at the source of content generation, destination of content reception and/or any point there between.

Semantic Firewall

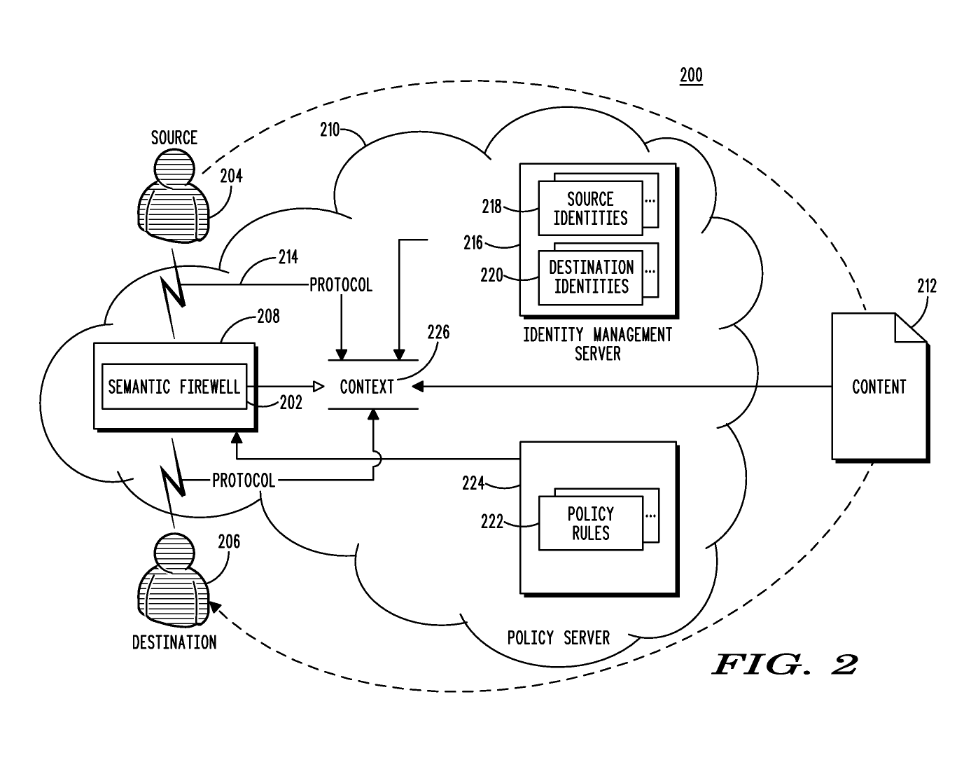

FIG. 2 shows a more detailed view of an operating environment 200 implementing a semantic firewall 202 according to one embodiment of the present invention. The semantic firewall 202 in the embodiment illustrated by FIG. 2 is situated at an application gateway component 208 and functions within a computer network 210. The application gateway component 208 monitors common information exchange protocols including, but not limited to, FTP (File Transfer Protocol), SMTP (Simple Mail Transfer Protocol), and HTTP (Hyper Text Transfer Protocol). The semantic firewall 202, in one embodiment, correlates information content using semantic analysis and then applies policies and role-based access control mechanisms (such as role-based rules) to determine if the information exchange is to be allowed to other destinations, both within the network 210 and in external computer networks (not shown).

Stated differently, the semantic firewall 202 can utilize techniques such as probabilistic latent semantic analysis (PLSA), latent semantic analysis (LSA), and/or semantic indexing to determine the semantic content of the electronically available information asset(s) associated with the request received from the source 204. The results of such an analysis yield a set of concepts that reflect the meaning of the content 212. A simple policy based approach can then be applied, using the context 226 and concept, to determine if the information exchange should be allowed.

Additional functionality of the semantic firewall 202 includes the ability to automatically expand the distribution of the information to required parties, additional sites, and other recipients, based on the application of policy and role-based access control mechanisms after the completion of associated semantic analysis. The semantic firewall 202 can be implemented as a standalone entity similar to a web-proxy, or as software based computational process running on a workstation, within a mail server or router, or as a module within a web-server such as the Apache Web Server. It should be noted that these are only examples of how the semantic firewall 202 can be implemented and do not limit the present invention to such implementations.

The following is a more detailed discussion on protecting and managing the dissemination of electronically available information assets using the semantic firewall 202. In particular, a source 204 generates a request for the transmission of information (content 212) across a well known protocol 214 such as (but not limited to) SMTP, HTTP, FTP, and SMS to a destination 206. The source 204 and destination 206, in this embodiment, are any electronic devices capable of transmitting data over communication networks, including but not limited to wired, wireless, satellite, and optical networks.

The semantic firewall 202, in one embodiment, receives/intercepts this request generated by the source 204. The semantic firewall 202 then uses one or more attributes to define the source 204 and one or more attributes to define the destination 206. This defining process includes but is not limited to defining concepts such as ports, addresses, protocol ID, Type of Service ID and other mechanisms for communicating QoS, and cell IDs of the request. The semantic firewall 202 communicates with an identity management server 216 to determine the identity of the originator of the request (source identity 218) as well as the identity of the intended destination of the request (destination identity 220). This facilitates the use of role-based access control (“RBAC”) to further protect information. It should be noted that identity is only one way that a role can be assigned, and hence RBAC policies can be used to apply content-specific rules to different people and applications.

The identification of the source 204 and the destination 206 includes the identification of roles that are associated to both the source 204 and the destination 206, respectively. The term “role” refers to the use of the role-object pattern as further discussed in Fowler, M., “Dealing with Roles”,((www.awl.com/cseng/titles/0-201-89542-0/apsupp/roles2-1.html)), which is hereby incorporated by reference in its entirety. In one embodiment, the semantic firewall 202 assumes the definition of a set of roles by the identity management server 216. Therefore, the semantic firewall 202 selects the correct role or set of roles to uniquely identify the source 204 and the destination 206.

Optionally, roles can be assigned to the content 212, which can be used to further refine the policy rules 222 that are to be used, as well as to a policy server 224 and/or the identity management server 216. Policy rules are further discussed in the co-pending U.S. patent application entitled “Managing Policy Rules And Associated Policy Components” with inventors Srinivasa C. SAMUDRALA et., Ser. No. 11/961,358, filed on Dec. 20, 2007, which is commonly owned and assigned hereto Motorola, Inc, and is incorporated by reference in its entirety. Policy rules are also further discussed in Strassner, John C.: “Policy Based Network Management”, San Francisco: Morgan Kaufmann Publishers, 2003, which is hereby incorporated by reference in its entirety.

Roles are very helpful if there are multiple entities (such as policy servers 224 and/or identity management servers 216) to choose from. Some of the embodiments of the present invention use roles to help determine semantic firewall decisions to be taken. It should be noted that the definition of context (based at least in part by the combination of source, destination, content, and other appropriate factors, such as (but not limited to) location and time) further enhances the definition of roles for servers and even for policy rules. This enables the semantic firewall 202 to seamlessly adapt its behavior to new contexts without changing its infrastructure in any way. Roles can also be defined and even negotiated through a simple, lightweight protocol.

In one embodiment, the semantic firewall 202 presupposes that all “originating” identities are available within the identity management server 216. The assignment of roles can be accomplished in a number of ways including, but not limited to, administrative actions to create roles and correlation rules (which appertain to semantic analysis discussed below) that are used to assign roles based on a rules-based mechanism. The assignment of roles can also be accomplished by the originator specifying a set of desired roles; the target can then examine these roles, optionally negotiate until both the sender and the receiver are satisfied, and then proceed using only those roles. This facilitates application-specific repurposing of the various embodiments of the present invention.

Given the fluid nature of communications, it is highly likely that at some point, a request for the identity of a destination (destination identity 220) fails to find a preconfigured destination. In such a case, there are a number of possible actions, including but not limited to the following. With respect to the first action, the semantic firewall 202 “kicks back” (i.e. denies the request for transmission and sends a notification of the denial back to the requesting entity) the request with a notice that information with regard to the destination 206 could be found. This notice can provide a link that can then be used to establish an identity record (e.g., destination identity 220) for the destination 206. This approach is attractive in that it establishes accountability with the originator (source 204) relative to the destination 206. It is possible to add a mechanism that requires approval of the destination identity record (e.g., destination identity 220) by a third party. This mechanism enables corporate control over trusted identities. For example, a request to establish a non-trusted identity can either bypass the third party verification or be blocked by corporate control.

With respect to a second action, the semantic firewall 202 applies a set of business policies to automatically establish non-trusted identity for unrecognized destinations. For example, the business policy can be that for any destination URI within a specified set of domains, a given role is associated to the identity. For example, assuming a company's point of origin, any destination in the domains of its known competitors would have the “competitor” role automatically associated to it. This is performed by using semantic content analysis of the URI. Again, the business policy can control what (if any) type of information is allowed to be sent to untrusted sites. For example, one or more ontologies (e.g., a specification of a lexicon) can be defined that specify the semantics associated with each role that the system uses.

Simple parsing of the URI enables the ontology to be queried, where the role “competitor” is read. A third action that the semantic firewall 202 can take is a combination of the first and second actions discussed above. Other actions can also be taken by the semantic firewall 202 such as (but not limited to) defining explicit messages in the information exchange protocol to deal with role assignment requests.

The semantic firewall 202 uses the source 204, source identity 218, destination 206, destination identity 220, content 212, and protocol 214 of transmission to establish a context 226 in which semantic analysis can be performed. Stated differently, the semantic firewall 202 generates a semantic context that is augmented with ontologies. The content 212 of the information exchange request received from the source 204 includes the information being exchanged, protocol related headers and/or routing information, as well as any attachments associated to the information exchange request.

The following is an example that illustrates why various embodiments of the present invention include protocol as part of the context. If the protocol of the transfer request is HTTP, and the destination 206 is a website URI, then policy conditions can be written that, for example, prevents a paper from being uploaded to a conference site that has not first been granted clearance for publication. Another example is that a business rule may demand that access to a company's code servers is only given through their corporate intranet. Hence, even though, for example, an employee of a company is correctly authenticated, that employee must still be denied access to the code servers of that company if that user is accessing the code server from a source external to the intranet of the company. In this example, the protocol easily allows determination as to whether the user is remote or not (i.e., it will be (for example) PPP if remote and (for example) Ethernet if local).

Once the semantic firewall 202 establishes the context 226, as discussed above, the semantic firewall 202 parses, scans, and/or examines the content 212, relative to the context 226. The parsing/scanning/examination mechanism, in one embodiment, functions in a multi-step fashion. Within this multi-step procedure the semantic firewall 202 searches/monitors for particular keywords, such as (but not limited to) “confidential proprietary” or “top secret” within the content 212, that are used within the organization to denote information that is not public. These keywords can then be used in conjunction with the context 226 to determine if the information exchange request should be allowed.

Assuming that no such keywords are found, techniques such as probabilistic latent semantic analysis (PLSA), latent semantic analysis (LSA), and/or semantic indexing can be applied to determine the semantic content of the electronically available information asset(s) associated with the request received from the source 204. The results of such an analysis yield a set of concepts that reflect the meaning of the content 212. A simple policy based approach can then be applied, using the context 226 and concept, to determine if the information exchange should be allowed. Techniques such as PLSA and LSA require a knowledge base for purposes of training. This training can be accomplished using corporate document repositories.

Based on the parsing/scanning/examination and the content 212, the semantic firewall 202, in one embodiment, uses a rules based method to determine if the information exchange should be allowed. The rules based method, in one embodiment, is an event-condition-action approach (i.e., a policy rule), wherein the request to send information (represents the event) that triggers the creation of context and content analysis is used to make a determination (expressed as conditions) as to whether or not to allow the exchange (action). However, other types of policy rule approaches can also be used. The co-pending U.S. patent application entitled “Managing Policy Rules And Associated Policy Components” with inventors Srinivasa C. SAMUDRALA et., Ser. No. 11/961,358, filed on Dec. 20, 2007, which is commonly owned and assigned hereto Motorola, Inc, and is incorporated by reference in its entirety, discusses event-conditions-actions in greater detail.

As can be seen, the semantic firewall 202 of the various embodiments of the present invention is not a firewall in the classic understanding of the term, but rather an application (and/or hardware) that annotates data/content in a manner that can be used by a filtering application at a later stage in the processing of the information. For example, some conventional firewalls accomplish filtering using cascading style sheets (CSS) in the rendering of the data at the client, which may allow access to data to which the client should not have access, as CSS processing occurs at the client, which means the data to be filtered is sent to the client. The semantic firewall 202 of the various embodiments of the present invention is advantageous over these conventional types of firewalls in that the semantic firewall 202 is a true firewall. In other words, information or requests for information are allowed or denied at the semantic firewall 202, not at some later, defeatable (from a security perspective) point in the information processing pipeline.

Process of Managing and Protecting the Dissemination of Electronically Available Information Assets

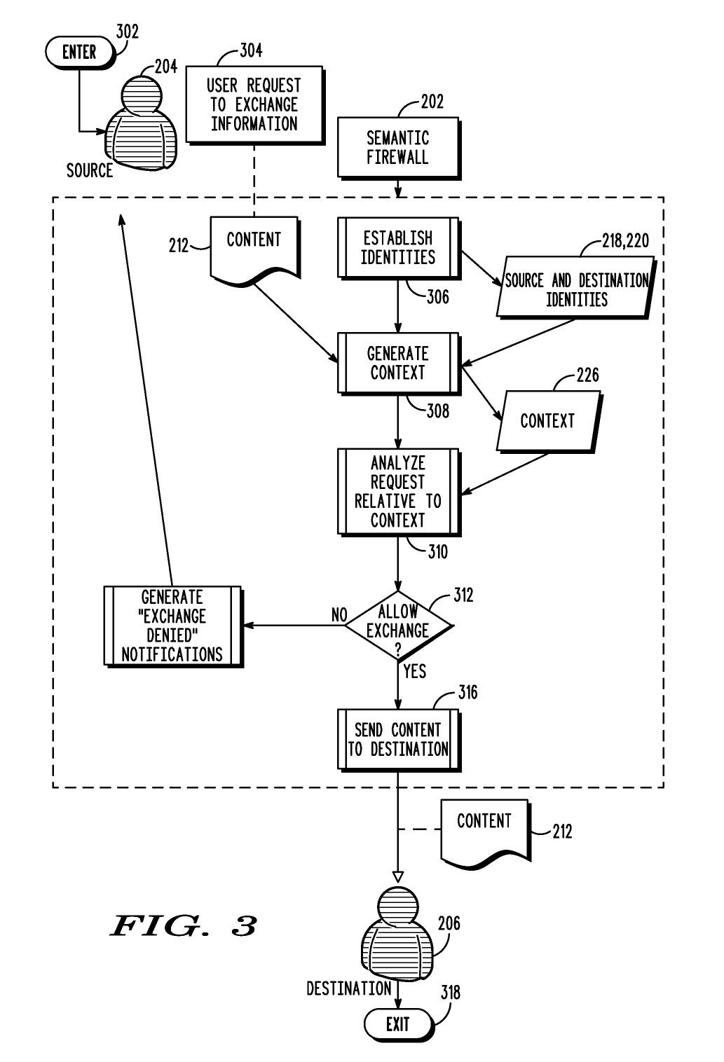

FIG. 3 is an operational flow diagram illustrating one example protecting electronically available information assets using a semantic firewall according to one embodiment of the present invention. The operational flow diagram of FIG. 3 begins at step 302 and flows directly to step 304. A source 204 sends a request to exchange information with a destination 206 (i.e., content 212) that is, at step 304, received/intercepted by the semantic firewall 202. The semantic firewall 202, at step 306, establishes the identities of the source 204 and the destination 206. For example, the semantic firewall 202 retrieves any available identities 218, 220 from the identity management server 216. The identification of the source 204 and the destination 206 includes the identification of roles that are associated to both the source 204 and the destination 206, respectively.

The semantic firewall 202, at step 308, generates a context 226 based on the source 204, source identity 218, destination 206, destination identity 220, content 212, and protocol 214 of transmission. These attributes allow the semantic firewall to establish a context that is augmented with ontologies. The semantic firewall 202, at step 310, analyzes the request relative to the context 226. For example, the semantic firewall the semantic firewall 202 parses, scans, and/or examines the content 212, relative to the context 226. Based on this analysis, the semantic firewall 202, at step 312, determines if the requested exchange should be allowed. If the result of this determination is negative, the semantic firewall 202, at step 314, generates “exchange denied” notifications and transmits these notifications to the source 204. If the result of this determination is positive, the semantic firewall 202, at step 316, sends the content 212 associated with the request for information exchange to the destination 206. The control flow then exits at step 318.

Information Processing System

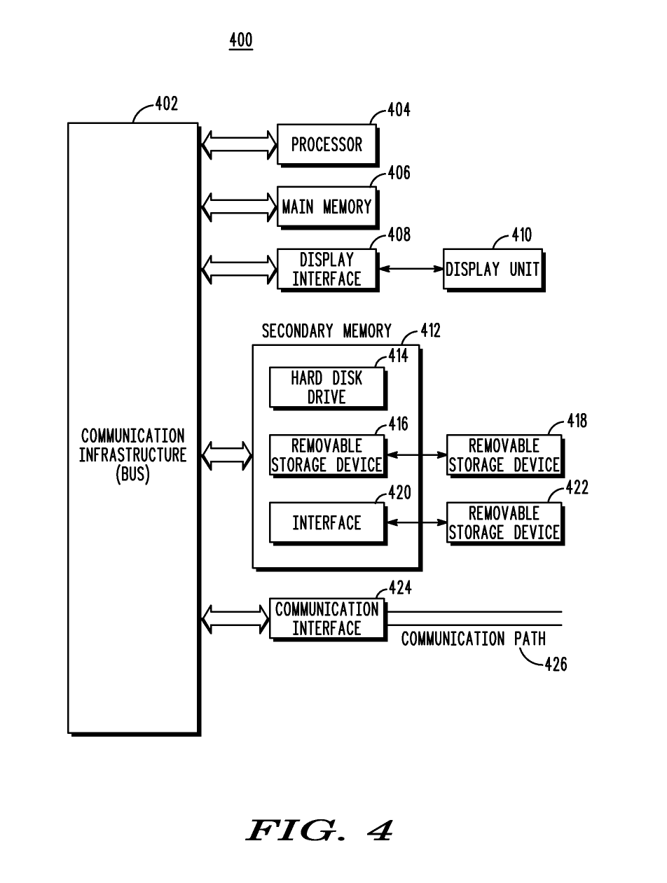

FIG. 4 is a high level block diagram illustrating a detailed view of a computing system 400 useful for implementing the semantic firewall 202 according to embodiments of the present invention. The computing system 400 is based upon a suitably configured processing system adapted to implement an exemplary embodiment of the present invention. For example, a personal computer, workstation, or the like, may be used.

In one embodiment of the present invention, the computing system 400 includes one or more processors, such as processor 404. The processor 404 is connected to a communication infrastructure 402 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 400 can include a display interface 408 that forwards graphics, text, and other data from the communication infrastructure 402 (or from a frame buffer) for display on the display unit 410. The computing system 400 also includes a main memory 406, preferably random access memory (RAM), and may also include a secondary memory 412 as well as various caches and auxiliary memory as are normally found in computer systems. The secondary memory 412 may include, for example, a hard disk drive 414 and/or a removable storage drive 416, representing a floppy disk drive, a magnetic tape drive, an optical disk drive, and the like. The removable storage drive 416 reads from and/or writes to a removable storage unit 418 in a manner well known to those having ordinary skill in the art.

Removable storage unit 418, represents a floppy disk, a compact disc, magnetic tape, optical disk, etc. which is read by and written to by removable storage drive 416. As are appreciated, the removable storage unit 418 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 412 may include other similar means for allowing computer programs or other instructions to be loaded into the computing system 400. Such means may include, for example, a removable storage unit 422 and an interface 420. Examples of such may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to the computing system 400.

The computing system 400, in this example, includes a communications interface 424 that acts as an input and output and allows software and data to be transferred between the computing system 400 and external devices or access points via a communications path 426. Examples of communications interface 424 may include a modem, a network interface (such as an Ethernet card), a communications port, a PCMCIA slot and card, etc. Software and data transferred via communications interface 424 are in the form of signals which may be, for example, electronic, electromagnetic, optical, or other signals capable of being received by communications interface 424. The signals are provided to communications interface 424 via a communications path (i.e., channel) 426. The channel 426 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product” and “computer program storage product” are used to generally refer to media such as main memory 406 and secondary memory 412, removable storage drive 416, and a hard disk installed in hard disk drive 414. The computer program products are means for providing software to the computer system. The computer readable medium allows the computer system to read data, instructions, messages or message packets, and other computer readable information from the computer readable medium.

Computer programs (also called computer control logic) are stored in main memory 406 and/or secondary memory 412. Computer programs may also be received via communications interface 424. Such computer programs, when executed, enable the computer system to perform the features of the various embodiments of the present invention as discussed herein. In particular, the computer programs, when executed, enable the processor 404 to perform the features of the computer system.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for limiting access to an electronically available information asset, the method comprising:
receiving a request from a source to exchange an electronically available information asset with at least one destination;
establishing, in response to the receiving, an identity associated with the source and the destination;
generating a semantically augmented context, wherein the semantically augmented context is information used to identify a meaning and a behavior of the context;
analyzing the request relative to the semantically augmented context for determining whether the request is to be one of allowed and denied;
in response to determining that the request is to be allowed,
allowing the source to exchange the electronically available information asset with the destination; and
in response to determining that the request is to be denied,
preventing the source from exchanging the electronically available information asset with the destination.

2. The method of claim 1, wherein generating a semantically augmented context further comprises:
establishing semantic relationships between at least one or more of the following entities:
source,
destination,
a set of electronic equivalents that enable the source and destination to be reached;
a content set associated with the electronically available information asset, and
a transmission protocol requested by the source in the request to exchange an electronically available information asset.

3. The method of claim 1, wherein the establishing an identity associated with the source and the at least one destination further comprises:
identifying at least one role associated with at least one of:
the source,
the destination, and
content associated with the electronically available information asset.

4. The method of claim 1, wherein analyzing the request relative to the semantically augmented context for determining whether the request is to be one of allowed and denied, further comprises:
analyzing the request relative to the semantically augmented context and with respect to at least one policy rule.

5. The method of claim 4, wherein the policy rule includes a structure that is based on an event-condition-action syntax.

6. The method of claim 4, wherein the at least one policy rule is one of:
a goal policy rule; and
a utility policy rule.

7. The method of claim 4, wherein the policy rule is a deontic logic rule.

8. The method of claim 1, wherein analyzing the request relative to the semantically augmented context for determining whether the request is to be one of allowed and denied, further comprises:
annotating content associated with the electronically available information asset with annotations that is to be used by a filtering application to further process the electronically available information asset.

9. The method of claim 1, further comprising:
sending the electronically available information asset to at least one other destination in response to determining that the request is to be allowed based on at least one of a policy rule and a role-based access rule.

10. An information processing system for limiting access to an electronically available information asset, the information processing system comprising:
a memory;
a processor communicatively coupled to the memory;
a semantic firewall module communicatively coupled to the memory and processor, wherein the semantic firewall module is adapted to:
receive a request from a source to exchange an electronically available information asset with at least one destination;
establish, in response to the request being received, an identity associated with the source and the destination;
generate a semantically augmented context, wherein the semantically augmented context is information used to identify a meaning and a behavior of the context;
analyze the request relative to the semantically augmented context for determining whether the request is to be one of allowed and denied;
in response to determining that the request is to be allowed,
allow the source to exchange the electronically available information asset with the destination; and
in response to determining that the request is to be denied,
prevent the source from exchanging the electronically available information asset with the destination.

11. The information processing system of claim 10, wherein the semantic firewall module is further adapted to generate a semantically augmented context by:
establishing semantic relationships between at least one or more of the following entities:
source,
destination,
a set of electronic equivalents that enable the source and destination to be reached;
a content set associated with the electronically available information asset, and
a transmission protocol requested by the source in the request to exchange an electronically available information asset.

12. The information processing system of claim 10, wherein the semantic firewall module is further adapted to establish an identity associated with the source and the at least one destination by:
identifying at least one role associated with at least one of:
the source,
the destination, and
content associated with the electronically available information asset.

13. The information processing system of claim 10, wherein the semantic firewall module is further adapted to analyze the request relative to the semantically augmented context for determining whether the request is to be one of allowed and denied by:
analyzing the request relative to the semantically augmented context and with respect to at least one policy rule.

14. The information processing system of claim 10, wherein the semantic firewall module is further adapted to analyze the semantically augmented context for determining whether the request is to be one of allowed and denied by:
annotating content associated with the electronically available information asset with annotations that is to be used by a filtering application to further process the electronically available information asset.

15. A network for limiting access to an electronically available information asset, the network comprising:
at least one source node;
at least one destination node; and
a least one information processing system communicatively coupled to the source node and the destination node, wherein the information processing system comprises:
a semantic firewall module, wherein the semantic firewall module is adapted to:
receive a request from the source node to exchange an electronically available information asset with the destination node;
establish, in response to the request being received, an identity associated with the source node and the destination node;
generate a semantically augmented context, wherein the semantically augmented context is information used to identify a meaning and a behavior of the context;
analyze the request relative to the semantically augmented context for determining whether the request is to be one of allowed and denied;
in response to determining that the request is to be allowed,
allow the source node to exchange the electronically available information asset with the destination node; and
in response to determining that the request is to be denied,
prevent the source from exchanging the electronically available information asset with the destination node.

16. The network of claim 15, wherein the semantic firewall module is further adapted to generate a semantically augmented context by:
establishing semantic relationships between at least one or more of the following entities:
source,
destination,
a set of electronic equivalents that enable the source and destination to be reached;
a content set associated with the electronically available information asset, and
a transmission protocol requested by the source in the request to exchange an electronically available information asset.

17. The network of claim 15, wherein the semantic firewall module is further adapted to analyze the request relative to the semantically augmented context for determining whether the request is to be one of allowed and denied by:
analyzing the request relative to the semantically augmented context and with respect to at least one policy rule.

18. The network of claim 15, wherein the semantic firewall module is further adapted to analyze the semantically augmented context for determining whether the request is to be one of allowed and denied by:
annotating content associated with the electronically available information asset with annotations that is to be used by a filtering application to further process the electronically available information asset.
